(19) United States
(12) Patent Application Publication
(10) Pub. No.: US 2024/0080112 A1
(43) Pub. Date: Mar. 7, 2024

(54) SIGNAL ANTI-NOISE-BASED INDOOR LOCALIZATION METHOD AND SYSTEM

(71) Applicant: Beijing Aerohydrodynamic Research Center, Beijing (CN)

(72) Inventors: Tianqi YANG, Beijing (CN); Mahesh BANAVAR, Beijing (CN); Jie SUN, Beijing (CN)

(21) Appl. No.: 18/388,541

(22) Filed: Nov. 10, 2023

Related U.S. Application Data
(63) Continuation of application No. PCT/CN2021/123241, filed on Oct. 12, 2021.

(51) Int. Cl. H04B 17/27; H04B 17/309; H04B 17/391

(52) U.S. Cl. CPC H04B 17/27; H04B 17/346; H04B 17/3912

(57) ABSTRACT

The present invention discloses a signal anti-noise-based indoor localization method and system. The method includes receiving a signal and a data packet broadcast by a signal base station laid indoors; determining a noisy distance from the signal base station to a to-be-localized terminal according to an RSSI value from the signal base station to the to-be-localized terminal; and localizing the to-be-localized terminal by using an indoor localization algorithm according to a distance value from the to-be-localized terminal to different signal base stations, a noisy distance from different signal base stations to the to-be-localized terminal, and location information of the signal base station laid indoors. The present invention can improve the noise resistance and accuracy of indoor localization.

### TECHNICAL FIELD

The present invention relates to the technical field of indoor localization, and particularly relates to a signal anti-noise-based indoor localization method and system.

### BACKGROUND

Target localization is an important problem in signal processing and sensor networks, which is wide in application fields, including security field (such as indoor rescue mentioned in E911 report), consumption electronics (position sensing with a mobile phone in shopping malls and hospitals) and health monitoring (sensing the location of a patient in the hospital to give timely care). However, satellite navigation and localization cannot solve all localization problems, especially indoor localization, so it is of great significance to study a target localization method without the satellite navigation.

In order to realize the indoor localization, the prior art specifically includes the following technologies:
1. Semi-definite programming (SDP) relaxation is used to solve the sensor localization problem in sensor network location (SNL) with noisy distance information. SNL is firstly modeled into a Euclidean distance matrix (EDM), and the projection of the semi-definite programming matrix is calculated to solve the convex optimization problem. By SDP approximation, an approximate location scheme may be provided for the sensor location.
2. Multidimensional scaling (MDS) connectivity measurement, that is, whether two sensors can be communicated can be used for calculating a localization sensor in a cheap wireless network. An algorithm based on Laplacian feature map is combined with an adaptive neighborhood weighting method, which can provide an accurate and low-complexity algorithm. The atomized Laplacian eigenimage is a manifold learning method optimized by eigendecomposition, which is non-iterative and finds a global optimal value.
3. A conventional method is to localize a target sensor by using time of arrival (TOA), angle of arrival (AOA), time difference of arrival (TDOA), received signal strength (RSS), and wife fingerprint identification technology.

However, in the prior art, the indoor target cannot be localized accurately under the condition of noise interference. Therefore, in order to solve the problem of low localization precision of the target sensor under the condition of noise interference, it is urgent to provide a new localization method or system.

### SUMMARY

In view of the above, the present invention provides a signal anti-noise-based indoor localization method and system, which can improve the noise resistance and accuracy of indoor localization.

To achieve the above purpose, the present invention provides the following solution:

A signal anti-noise-based indoor localization method includes:
receiving a signal and a data packet broadcast by a signal base station laid indoors, wherein the data packet includes a distance value from the signal base station to a to-be-localized terminal and location information of the signal base station; and an RSSI value from the signal base station to the to-be-localized terminal is determined according to signal intensity of the signal;
determining a noisy distance from the signal base station to the to-be-localized terminal according to the RRSI value from the signal base station to the to-be-localized terminal;
localizing the to-be-localized terminal by using an indoor localization algorithm according to the distance value from the to-be-localized terminal to different signal base stations, the noisy distance from different signal base stations to the to-be-localized terminal, and the location information of the signal base station laid indoors.

Optionally, localizing the to-be-localized terminal by using the indoor localization algorithm after optimization by a weight function algorithm according to the distance value from the to-be-localized terminal to different signal base stations, the noisy distance from different signal base stations to the to-be-localized terminal, and the location information of the signal base station laid indoor specifically includes:
determining an indoor location of the to-be-localized terminal by using a formula

$${min}_{x ∈ {ℝ}^{p}} J ( x , Y ; δ ; ω ) ;$$

wherein x is the indoor location of the to-be-localized terminal, Y is the location of the signal base station,

$$J ( x , Y ; δ ; ω ) = {\sum }_{i = 1}^{m} {{w}_{i} ( {d ( x , {y}_{i} )}^{2} - {δ}_{i}^{2} )}^{2} ,$$

δ₀ is a noisy distance from an i^{th} signal base station to the to-be-localized terminal, ωᵢ is a weight value of the distance value from the i^{th} signal base station to the to-be-localized terminal and the noisy distance from the i^{th} signal base station to the to-be-localized terminal, and d(x,yᵢ) is the distance value from the i^{th} signal base station to the to-be-localized terminal.

Optionally, determining the indoor location of the to-be-localized terminal by using the formula

$${min}_{x ∈ {ℝ}^{p}} J ( x , Y ; δ ; ω )$$

specifically includes:
converting

$${min}_{x ∈ {ℝ}^{p}} J ( x , Y ; δ ; ω )$$

to a constrained quadratic optimization problem for solution, and determining the indoor location of the to-be-localized terminal.

Optionally, after localizing the to-be-localized terminal by using the indoor localization algorithm after optimization by the weight function algorithm according to the distance value from the to-be-localized terminal to different signal base stations, the noisy distance from different signal base stations to the to-be-localized terminal, and the location information of the signal base station laid indoor, the method further includes:

performing navigation according to the localized location of the to-be-localized terminal.

A signal anti-noise-based indoor localization system includes:
a data receiving module, configured to receive a signal and a data packet broadcast by a signal base station laid indoors, wherein the data packet includes a distance value from the signal base station to a to-be-localized terminal and location information of the signal base station; and an RSSI value from the signal base station to the to-be-localized terminal is determined according to signal intensity of the signal;
a noisy distance module, configured to determine a noisy distance from the signal base station to the to-be-localized terminal according to the RRSI value from the signal base station to the to-be-localized terminal;
a localization module, configured to localize the to-be-localized terminal by using an indoor localization algorithm according to the distance value from the to-be-localized terminal to different signal base stations, the noisy distance from different signal base stations to the to-be-localized terminal, and the location information of the signal base station laid indoor.

Optionally, the localization module specifically includes:
a localization unit, configured to determine an indoor location of the to-be-localized terminal by using a formula

$${min}_{x ∈ {ℝ}^{p}} J ( x , Y ; δ ; ω ) ;$$

wherein x is the indoor location of the to-be-localized terminal, Y is the location of the signal base station,

$$J ( x , Y ; δ ; ω ) = {\sum }_{i = 1}^{m} {{w}_{i} ( {d ( x , {y}_{i} )}^{2} - {δ}_{i}^{2} )}^{2} ,$$

δᵢ is a noisy distance from an i^{th} signal base station to the to-be-localized terminal, ωᵢ is a weight value of the distance value from the i^{th} signal base station to the to-be-localized terminal and the noisy distance from the i^{th} signal base station to the to-be-localized terminal, and d(x,yᵢ) is the distance value from the i^{th} signal base station to the to-be-localized terminal.

Optionally, the localization unit specifically includes:
a localization subunit, configured to convert

$${min}_{x ∈ {ℝ}^{p}} J ( x , Y ; δ ; ω )$$

to a constrained quadratic optimization problem for solution, and determine the indoor location of the to-be-localized terminal.

According to specific embodiments of the present invention, the present invention discloses the following technical effects: the noisy distance from different signal base stations to the to-be-localized terminal is determined by the signal intensity, and then the to-be-localized terminal is localized by using the indoor localization algorithm according to the distance value from the to-be-localized terminal to different signal base stations, the noisy distance from different signal base stations to the to-be-localized terminal, and the location information of the signal base station laid indoor. Further, the technical problem of low localization accuracy of the target sensor under the condition of noise interference can be solved, and the noise resistance and accuracy of indoor localization can be improved.

### DESCRIPTION OF DRAWINGS

To more clearly describe the technical solutions in the embodiments of the present invention or in prior art, the drawings required to be used in the embodiments will be simply presented below. Apparently, the drawings in the following description are merely some embodiments of the present invention, and for those skilled in the art, other drawings can also be obtained according to these drawings without contributing creative labor.

FIG. 1 is a flow chart of a signal anti-noise-based indoor localization method provided by the present invention;

FIG. 2 is a principle diagram of a signal anti-noise-based indoor localization method provided by the present invention;

FIG. 3 is a structural schematic diagram of a signal anti-noise-based indoor localization system provided by the present invention.

### DETAILED DESCRIPTION

The technical solutions in the embodiments of the present invention will be clearly and fully described below in combination with the drawings in the embodiments of the present invention. Apparently, the described embodiments are merely part of the embodiments of the present invention, not all of the embodiments. Based on the embodiments in the present invention, all other embodiments obtained by those ordinary skilled in the art without contributing creative labor will belong to the protection scope of the present invention.

A purpose of the present invention is to provide a signal anti-noise-based indoor localization method and system, which can improve the noise resistance and accuracy of indoor localization.

To make the above purpose, characteristics and advantages of the present invention more apparent and understood, the present invention is further described in detail below in combination with the drawings and embodiments.

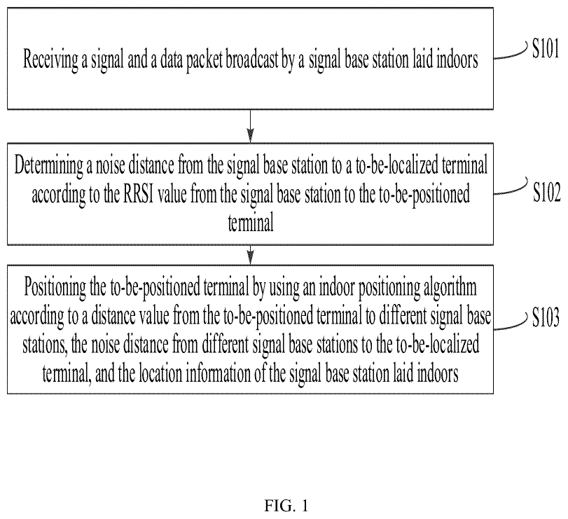

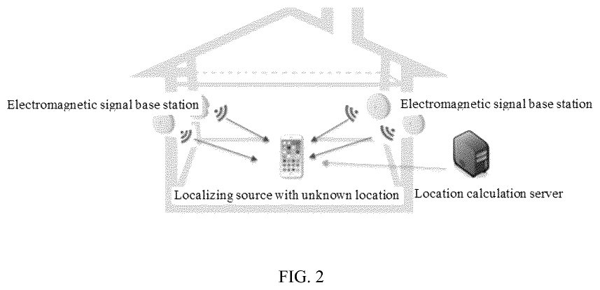

FIG. 1 is a flow chart of a signal anti-noise-based indoor localization method provided by the present invention; and FIG. 2 is a principle diagram of the signal anti-noise-based indoor localization method provided by the present invention. As shown in FIG. 1 and FIG. 2, the signal anti-noise-based indoor localization method provided by the present invention includes:
S101: receiving a signal and a data packet broadcast by a signal base station laid indoors, wherein the data packet includes a distance value from the signal base station to a to-be-localized terminal and location information of the signal base station, and an RSSI value from the signal base station to the to-be-localized terminal is determined according to signal intensity of the signal;

Prior to S101, the method further includes:
laying a plurality of signal base stations indoors, wherein the signal base station is preferably an electromagnetic signal base station.
S102: determining a noisy distance from the signal base station to the to-be-localized terminal according to the RRSI value from the signal base station to the to-be-localized terminal;
S103: localizing the to-be-localized terminal by using an indoor localization algorithm according to the distance value from the to-be-localized terminal to different signal base stations, the noisy distance from different signal base stations to the to-be-localized terminal, and the location information of the signal base station laid indoor.
S103 specifically includes:
determining the indoor location of the to-be-localized terminal by using a formula

$${min}_{x ∈ {ℝ}^{p}} J ( x , Y ; δ ; w ) ,$$

wherein through a minimized pressure equation, a corresponding value when the above formula is infinitely approximate to 0 is the indoor location of the to-be-localized terminal.
wherein x is the indoor location of the to-be-localized terminal, Y is the location of the signal base station,

$$J ( x , Y ; δ ; ω ) = {\sum }_{i = 1}^{m} {{w}_{i} ( {d ( x , {y}_{i} )}^{2} - {δ}_{i}^{2} )}^{2} ,$$

δᵢ is a noisy distance from an i^{th} signal base station to the to-be-localized terminal, ωᵢ is a weight value of the distance value from the i^{th} signal base station to the to-be-localized terminal and the noisy distance from the i^{th} signal base station to the to-be-localized terminal, and d(x,yᵢ) is the distance value from the i^{th} signal base station to the to-be-localized terminal.

In the formula, δᵢ=f(dᵢ,ξᵢ), and δᵢ is a noisy distance from the i^{th} signal base station to a target point, and is a measured value. dᵢ is an actual distance from the i^{th} signal base station to the target point, and ξᵢ represents noise from the i^{th} signal base station to the target point.

The above formula is transformed as follows:

δᵢ=f(dᵢ,ξᵢ)=(dᵢ^{γ}+τᵢ)^{1/γ};
wherein γ represents different types of signals, and is the electromagnetic signal used herein, so γ=1.

Further,

$$J ( x , Y ; δ ; ω ) = {\sum }_{i = 1}^{m} {{w}_{i} ( {d ( x , {y}_{i} )}^{2} - {δ}_{i}^{2} )}^{2} ,$$

is determined;

Determining the indoor location of the to-be-localized terminal by using the formula

$${min}_{x ∈ {ℝ}^{p}} J ( x , Y ; δ ; ω )$$

specifically includes:
converting

$${min}_{x ∈ {ℝ}^{p}} J ( x , Y ; δ ; ω )$$

to a constrained quadratic optimization problem for solution, and determining the indoor location of the to-be-localized terminal.

A specific solution process is as follows:

A vector z=[x^{T},α]^{T}∈ [symbol] ^{p+1} is defined, and the formula

$${min}_{x ∈ {ℝ}^{p}} J ( x , Y ; δ ; w )$$

is equivalent to:

$${min}_{z ∈ {ℝ}^{p + 1}} \{ q ( z ) : c ( z ) = 0 \} ;$$

q (z) and c (z) are defined as follows:

$$\{ \begin{matrix}q ( z ) = {‖ W ( Mz - b ) ‖}^{2} = {( WMz - Wb )}^{⊤} ( WMz - Wb ) \\ c ( z ) = {z}^{⊤} Dz + 2 {f}^{⊤} z ,\end{matrix} ;$$

Each variable is defined as follows:

$$and W = [ \begin{matrix}\sqrt{{w}_{1}} & & \\ & ⋱ & \\ & & \sqrt{{w}_{m}}\end{matrix} ] , M = [ \begin{matrix}- 2 {y}_{1}^{⊤} & 1 \\ ⋮ & 1 \\ - 2 {y}_{m}^{⊤} & 1\end{matrix} ] , b = [ \begin{matrix}{δ}_{1}^{2} - {‖ {y}_{1} ‖}^{2} \\ ⋮ \\ {δ}_{m}^{2} - {‖ {y}_{m} ‖}^{2}\end{matrix} ]$$

$$D = [ \begin{matrix}{I}_{p \times p} & {0}_{p \times 1} \\ {0}_{1 \times p} & 0\end{matrix} ] , b = [ \begin{matrix}{δ}_{1}^{2} - {‖ {y}_{1} ‖}^{2} \\ ⋮ \\ {δ}_{m}^{2} - {‖ {y}_{m} ‖}^{2}\end{matrix} ] , f = [ \begin{matrix}{0}_{p \times 1} \\ - 0.5\end{matrix} ]$$

After S103, the method further includes:

performing navigation according to the localized location of the to-be-localized terminal.

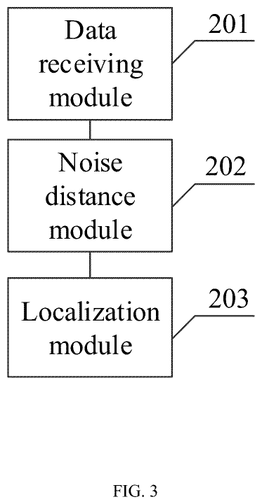

FIG. 3 is a structural schematic diagram of a signal anti-noise-based indoor localization system provided by the present invention. As shown in FIG. 3, the signal anti-noise-based indoor localization system provided by the present invention includes:
a data receiving module 201, configured to receive a signal and a data packet broadcast by a signal base station laid indoors, wherein the data packet includes a distance value from the signal base station to a to-be-localized terminal and location information of the signal base station; and an RSSI value from the signal base station to the to-be-localized terminal is determined according to signal intensity of the signal;
a noisy distance module 202, configured to determine a noisy distance from the signal base station to the to-be-localized terminal according to the RRSI value from the signal base station to the to-be-localized terminal;
a localization module 203, configured to localize the to-be-localized terminal by using an indoor localization algorithm according to the distance value from the to-be-localized terminal to different signal base stations, the noisy distance from different signal base stations to the to-be-localized terminal, and the location information of the signal base station laid indoor.

The localization module 203 specifically includes:
a localization unit, configured to determine an indoor location of the to-be-localized terminal by using a formula

$${min}_{x ∈ {ℝ}^{p}} J ( x , Y ; δ ; w ) ;$$

wherein x is the indoor location of the to-be-localized terminal, Y is the location of the signal base station,

$$J ( x , Y ; δ ; w ) = {\sum }_{i = 1}^{m} {{w}_{i} ( {d ( x , {y}_{i} )}^{2} - {δ}_{i}^{2} )}^{2} ,$$

δᵢ is a noisy distance from an i^{th} signal base station to the to-be-localized terminal, ωᵢ is a weight value of the distance value from the i^{th} signal base station to the to-be-localized terminal and the noisy distance from the i^{th} signal base station to the to-be-localized terminal, and d(x,yᵢ) is the distance value from the i^{th} signal base station to the to-be-localized terminal.

The localization unit specifically includes:
a localization subunit, configured to convert

$${min}_{x ∈ {ℝ}^{p}} J ( x , Y ; δ ; w )$$

to a constrained quadratic optimization problem for solution, and determine the indoor location of the to-be-localized terminal.

Each embodiment in the description is described in a progressive way. The difference of each embodiment from each other is the focus of explanation. The same and similar parts among all of the embodiments can be referred to each other.

Specific individual cases are applied herein for elaborating the principle and embodiments of the present invention. The illustration of the above embodiments is merely used for helping to understand the method and the core thought of the present invention. Meanwhile, for those ordinary skilled in the art, specific embodiments and the application scope may be changed in accordance with the thought of the present invention. In conclusion, the contents of the description shall not be interpreted as a limitation to the present invention.

What is claimed is:

1. A signal anti-noise-based indoor localization method, comprising:
receiving a signal and a data packet broadcast by a signal base station laid indoors, wherein the data packet comprises a distance value from the signal base station to a to-be-localized terminal and location information of the signal base station; and an RSSI value from the signal base station to the to-be-localized terminal is determined according to signal intensity of the signal;
determining a noisy distance from the signal base station to the to-be-localized terminal according to the RRSI value from the signal base station to the to-be-localized terminal;
localizing the to-be-localized terminal by using an indoor localization algorithm according to the distance value from the to-be-localized terminal to different signal base stations, the noisy distance from different signal base stations to the to-be-localized terminal, and the location information of the signal base station laid indoors.

2. The signal anti-noise-based indoor localization method according to claim 1, wherein localizing the to-be-localized terminal by using the indoor localization algorithm after optimization by a weight function algorithm according to the distance value from the to-be-localized terminal to different signal base stations, the noisy distance from different signal base stations to the to-be-localized terminal, and the location information of the signal base station laid indoor specifically comprises:
determining an indoor location of the to-be-localized terminal by using a formula
$${min}_{x ∈ {ℝ}^{p}} J ( x , Y ; δ ; w ) ;$$
wherein x is the indoor location of the to-be-localized terminal, Y is the location of the signal base station,
$$J ( x , Y ; δ ; w ) = {\sum }_{i = 1}^{m} {{w}_{i} ( {d ( x , {y}_{i} )}^{2} - {δ}_{i}^{2} )}^{2} ,$$
δᵢ is a noisy distance from an i^{th} signal base station to the to-be-localized terminal, ωᵢ is a weight value of the distance value from the i^{th} signal base station to the to-be-localized terminal and the noisy distance from the i^{th} signal base station to the to-be-localized terminal, and d(x,yᵢ) is the distance value from the i^{th} signal base station to the to-be-localized terminal.

3. The signal anti-noise-based indoor localization method according to claim 2, wherein determining the indoor location of the to-be-localized terminal by using the formula
$${min}_{x ∈ {ℝ}^{p}} J ( x , Y ; δ ; w )$$
specifically comprises:
converting
$${min}_{x ∈ {ℝ}^{p}} J ( x , Y ; δ ; w )$$
to a constrained quadratic optimization problem for solution, and determining the indoor location of the to-be-localized terminal.

4. The signal anti-noise-based indoor localization method according to claim 1, further comprising, after localizing the to-be-localized terminal by using the indoor localization algorithm after optimization by the weight function algorithm according to the distance value from the to-be-localized terminal to different signal base stations, the noisy distance from different signal base stations to the to-be-localized terminal, and the location information of the signal base station laid indoor:
performing navigation according to the localized location of the to-be-localized terminal.

5. A signal anti-noise-based indoor localization system, comprising:
a data receiving module, configured to receive a signal and a data packet broadcast by a signal base station laid indoors, wherein the data packet comprises a distance value from the signal base station to a to-be-localized terminal and location information of the signal base station; and an RSSI value from the signal base station to the to-be-localized terminal is determined according to signal intensity of the signal;
a noisy distance module, configured to determine a noisy distance from the signal base station to the to-be-localized terminal according to the RRSI value from the signal base station to the to-be-localized terminal;
a localization module, configured to localize the to-be-localized terminal by using an indoor localization algorithm according to the distance value from the to-be-localized terminal to different signal base stations, the noisy distance from different signal base stations to the to-be-localized terminal, and the location information of the signal base station laid indoor.

6. The signal anti-noise-based indoor localization system according to claim 5, wherein the localization module specifically comprises:
a localization unit, configured to determine an indoor location of the to-be-localized terminal by using a formula
$${min}_{x ∈ {ℝ}^{p}} J ( x , Y ; δ ; w ) ;$$
wherein x is the indoor location of the to-be-localized terminal, Y is the location of the signal base station,
$$J ( x , Y ; δ ; w ) = {\sum }_{i = 1}^{m} {{w}_{i} ( {d ( x , {y}_{i} )}^{2} - {δ}_{i}^{2} )}^{2} ,$$
δᵢ is a noisy distance from an i^{th} signal base station to the to-be-localized terminal, ωᵢ is a weight value of the distance value from the i^{th} signal base station to the to-be-localized terminal and the noisy distance from the i^{th} signal base station to the to-be-localized terminal, and d(x,yᵢ) is the distance value from the i^{th} signal base station to the to-be-localized terminal.

7. The signal anti-noise-based indoor localization system according to claim 6, wherein the localization unit specifically comprises:
a localization subunit, configured to convert
$${min}_{x ∈ {ℝ}^{p}} J ( x , Y ; δ ; w )$$
to a constrained quadratic optimization problem for solution, and determine the indoor location of the to-be-localized terminal.
